(19) United States
(12) Patent Application Publication
(10) Pub. No.: US 2015/0095050 A1
(43) Pub. Date: Apr. 2, 2015

(54) DENORMALIZATION OF HEALTHCARE DATA

(71) Applicant: CERNER INNOVATION, INC., Kansas City, KS (US)

(72) Inventors: JOHN CHRISTOPHER MURRISH, Overland Park, KS (US); JOHN Q. DEVERTER, Liberty, MO (US); MARK DAVENPORT, Overland Park, KS (US); RAMKUMAR BOMMIREDDIPALLI, Overland Park, KS (US); RENISH PALAPETTY, Overland Park, KS (US)

(73) Assignee: CERNER INNOVATION, INC., Kansas City, KS (US)

(21) Appl. No.: 14/044,565

(22) Filed: Oct. 2, 2013

(51) Int. Cl. G06F 19/00

(52) U.S. Cl. CPC G06F 19/327
USPC 705/2

(57) ABSTRACT

Systems, methods, and computer-readable media for denormalizing healthcare data are provided. An indication a patient has been added to a tracking list is received. The tracking list is determined to be associated with a primed view. Data is retrieved for the patient. The data for the patient is cached into the primed view before a clinician requests the data.

### BACKGROUND

The advent of powerful servers, large-scale data storage and other information infrastructure has spurred the development of advanced data warehousing. Structured query language (SQL) engines and inexpensive large disk arrays have for instance been harnessed in financial, scientific, medical, and other fields to capture vast streams of transactional, experimental, and other data.

In the case of medical data management, the task of querying, receiving, conditioning, and analyzing large quantities of clinical information is particularly challenging. The sources of medical data for an organization, for instance, may include various hospitals, laboratories, research or other facilities, each of which may generate data records at different times and in widely varying formats. Clinical systems are often extremely large, with a high volume of data (e.g., results and/or orders), and retrieving what is necessary to meet business requirements is inefficient. That is in part because querying the various data sources requires significant processing overhead. Queries of that data are utilized, for example, by clinicians for each encounter with each patient. Each query may be made to tables having thousands of rows for a patient with many encounters. This heavy back-end processing is time-consuming and particularly burdensome to the server and network infrastructure, as well as to the clinician.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer storage media for denormalization of healthcare data. An indication a patient has been added to a tracking list is received. The tracking list is determined to be associated with a primed view. Data is received for the patient. The data for the patient is cached into the primed view before a clinician requests the data.

### BRIEF DESCRIPTION OF THE DRAWINGS

The present invention is described in detail below with reference to the attached drawings figures, wherein:

FIG. 1 is a block diagram of an exemplary computing system suitable for use in implementing embodiments of the present invention;

FIG. 2 schematically shows a network environment suitable for performing embodiments of the invention;

FIG. 3 is a flow diagram showing a method for denormalizing healthcare data, in accordance with an embodiment of the present invention; and

FIG. 4 is a flow diagram showing a method for denormalizing healthcare data, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

A primed view refers to a preloaded set of data of a specific entity type loaded for a population of patients. Each patient in the population has a row of data for each encounter if the encounter has qualifying data. The data is loaded prior to a user requesting the data. Security and privileges of the proxy personnel on the view restricts what data is loaded into the primed view. This typically reflects the security settings of users with the broadest access that will leverage a particular primed view. Proxy personnel with access to facilities are based on the broadest groups of facilities users have access to. Proxy personnel may have a position with access privileges inclusive of all users that will share the primed view. Security and privileges of the user accessing a primed view restricts what data is read from the primed view for a particular user. If the user has access to more facilities than the proxy personnel or additional privileges, the additional information is not visible from the primed view. A primed view user group is utilized to determine what users can access a given primed view. Each user may be assigned to one or more primed view user groups. Only users assigned to the group associated to the primed view may utilize the primed view.

Embodiments of the present invention can improve performance of data retrieval and quickly display the data to end users. Embodiments present advantages over other systems by executing discrete queries and preparing the information to retrieve and display before the user requests it.

Accordingly, one embodiment of the present invention is directed to one or more computer hardware storage media storing computer-useable instructions that, when used by one or more computing devices, cause the one or more computing devices to perform a method of facilitating selective denormalization of healthcare data. The method includes receiving an indication a patient has been added to a tracking list. The tracking list is determined to be part of a primed view. Data is received for the patient. The data for the patient is cached into the primed view.

Another embodiment of the present invention is directed to one or more computer hardware storage media storing computer-useable instructions that, when used by one or more computing devices, cause the one or more computing devices to perform a method of facilitating selective denormalization of healthcare data. A tracking list of patients is prepared based on a schedule of appointments. Data for each patient in the tracking list is retrieved. The data may be limited in time and selected based on a condition associated with the patients, a role associated with a clinician, and/or a unit associated with a healthcare facility. The data is cached into a primed view. The primed view may be available to the clinician without the clinician requesting the data. An indication updated data is available for one or more patients is received. The data is refreshed with the updated data in the primed view.

Yet another embodiment of the present invention includes a system for facilitating selective denormalization of healthcare data. The system includes one or more processors coupled to a computer hardware storage medium, the computer hardware storage medium having stored thereon a plurality of computer software components executable by the processor. The computer software components include a tracking component that receives an indication a patient has been added to a tracking list. A retrieval component retrieves data for each patient in the tracking list. The data may be limited in time and selected based on a condition associated with the patients, a role associated with a clinician, and/or a unit associated with a healthcare facility. A cache component caches the data into a primed view. The primed view may be provided before a user initiates a query. A refresh component retrieves updated data and refreshes the data with the updated data in the primed view.

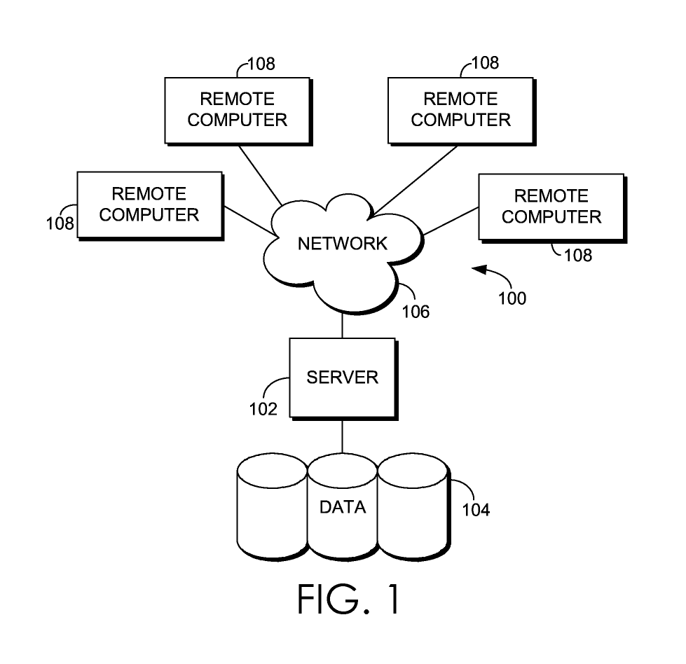

Having briefly described embodiments of the present invention, an exemplary operating environment suitable for use in implementing embodiments of the present invention is described below. Referring to FIG. 1 an exemplary computing environment with which embodiments of the present invention may be implemented is illustrated and designated generally as reference numeral 20. It will be understood and appreciated by those of ordinary skill in the art that the illustrated medical information computing system environment 20 is merely an example of one suitable computing environment and is not intended to suggest any limitation as to the scope of use or functionality of the invention. Neither should the medical information computing system environment 20 be interpreted as having any dependency or requirement relating to any single component or combination of components illustrated therein.

Embodiments of the present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

Embodiments of the present invention may be described in the general context of computer-executable instructions, such as program modules, being executed by a computer. Generally, program modules include, but are not limited to, routines, programs, objects, components, and data structures that perform particular tasks or implement particular abstract data types. Embodiments of the present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary computing environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer readable media. Computer readable media can be any available media that may be accessed by server 102, and includes volatile and nonvolatile media, as well as removable and non-removable media. By way of example, and not limitation, computer readable media may include computer storage media and communication media; computer storage media excludes signals per se. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 104, provide storage of computer readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnections are well known. Accordingly, additional details concerning the internal construction of the server 102 and the remote computers 108 are not further disclosed herein.

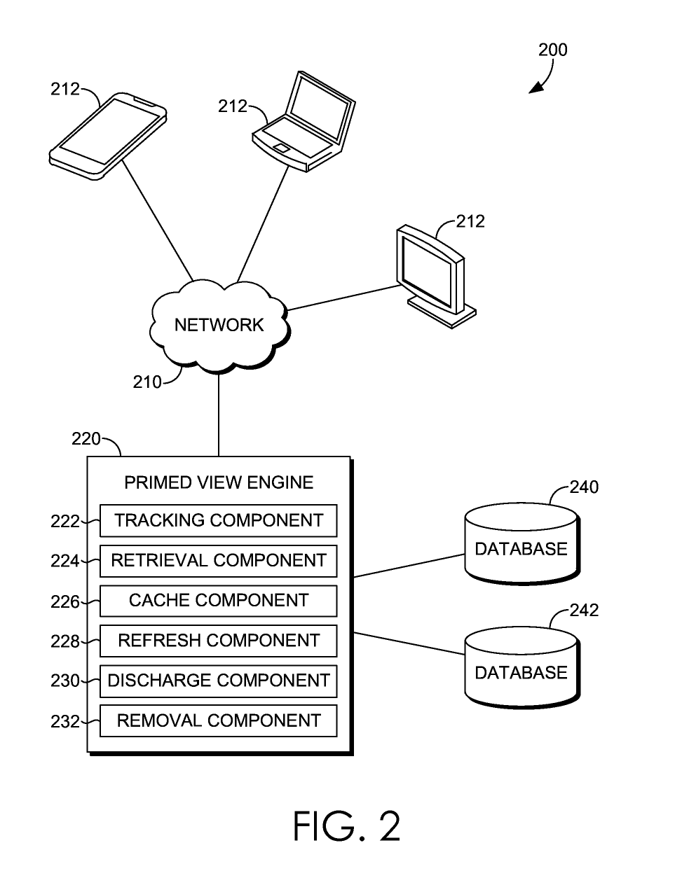

Referring now to FIG. 2, a block diagram is provided illustrating an exemplary computing system 200 in which embodiments of the present invention may be employed. Generally, the computing system 200 illustrates an environment in which healthcare data may be denormalized and cached for a user without the user executing a query. The computing system 200 may be a comprehensive computing system within a clinical environment similar to the exemplary computing system 20 discussed above with reference to FIG. 1. Among other components not shown, the computing system 200 generally includes user display devices 212 (e.g., mobile devices, touch screens or tablet devices, workstations, and the like), a primed view engine 220, a database 240, and a primed view database 242 in communication with one another via a network 210. The network 210 may include, without limitation, one or more local area networks (LANs) and/or wide area networks (WANs). Such networking environments are commonplace in offices, enterprise-wide computer networks, intranets and the Internet. Accordingly, the network 210 is not further described herein.

It should be understood that any number of user display devices 212 and/or primed view engines 220 may be employed in the computing system 200 within the scope of embodiments of the present invention. Each may comprise a single device/interface or multiple devices/interfaces cooperating in a distributed environment. For instance, the primed view engine 220 may comprise multiple devices and/or modules arranged in a distributed environment that collectively provide the functionality of the primed view engine 220 described herein. Additionally, other components or modules not shown also may be included within the computing system 200.

In some embodiments, one or more of the illustrated components/modules may be implemented as stand-alone applications. In other embodiments, one or more of the illustrated components/modules may be implemented via a user display device 212, the primed view engine 220, or as an Internet-based service. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on and/or shared by any number of primed view engines and/or user display devices. By way of example only, the primed view engine 220 might be provided as a single computing device (as shown), a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The primed view engine 220 is configured to, among other things, provide selective denormalization of healthcare data prior to a user executing a query for data associated with a particular patient. As illustrated, in various embodiments, the primed view engine 220 includes a tracking component 222, a retrieval component 224, a cache component 228, a refresh component 228, a discharge component 230, a removal component. The primed view engine 220 is communitively coupled to a database 240 comprising healthcare data and a primed view database 242. The primed view database 242 may comprise a subset of the healthcare data stored in the database 240 (e.g., orders and/or results for a select population of patients).

The tracking component 222 receives an indication a patient has been added to a tracking list. In one embodiment, the tracking component builds the tracking list based on a particular condition associated with a group of patients, a role associated with a clinician treating a group of patients, and/or a unit associated with a healthcare facility that treats a group of patients. This allows the tracking list to be tailored to a particular group of patients, for a particular clinician, or for a particular unit. In another embodiment, the tracking component builds the tracking list based on a schedule of patients that have appointments on a particular day at a particular facility or with a particular clinician. This allows the tracking list to be automatically populated each day with expected patients.

The retrieval component 224 retrieves data for each patient in the tracking list. The data may be limited in time. For example, rather than retrieving all orders or all results for a patient, only the most recent orders or results may be retrieved. Similarly, only active orders or recently cancelled orders may be retrieved. The data may further be selected based on a condition associated with the patients, a role associated with a clinician, and/or a unit associated with a healthcare facility. For example, only data that is clinically relevant to the current encounter may be retrieved, such as data associated with a particular condition. In one embodiment, the tracking list may be built based on this condition to retrieve a particular subset of data that is relevant to that condition. In another embodiment, a particular subset of data may be retrieved based on data that is relevant to a particular role associated with a clinician. In another embodiment, a particular subset of data may be retrieved based on data that is relevant to a particular unit associated with a healthcare facility.

The cache component 226 caches the data into a primed view. The data may be cached into primed view before a user initiates a query. In one embodiment, the data for a particular patient is cached into the primed view before the patient is admitted. In one embodiment, the data for the patient is cached into the primed view before the patient arrives at the healthcare facility. In one embodiment, the data for the patient is cached into the primed view when the patient checks in to the healthcare facility. This allows the clinician to view the most pertinent information for each patient during the encounter without being forced to sort through or query data that is no longer current or relevant.

The refresh component 228 retrieves updated data and refreshes the data with the updated data in the primed view. The updated data may reflect data (e.g., an order or result) that has been entered by the clinician viewing the primed view or by another clinician that has recently had an encounter with the patient. In one embodiment, the primed view is updated automatically when the updated data is received. In one embodiment, the primed view is updated when the refresh component 228 receives an indication from a clinician to update the data in the primed view.

In one embodiment, the discharge component 230 indicates an appointment has ended for the patient or the patient has been discharged. The removal component 232 may remove the data for the patient from the primed view and remove the patient from the tracking list. In one embodiment, the removal component 232 removes the data for the patient from the primed view and removes the patient from the tracking list automatically when the discharge component 230 indicates the appointment has ended or the patient has been discharged. In one embodiment, the removal component 232 removes the data for the patient from the primed view and removes the patient form the tracking list when an indication is received from the clinician that indicates the data is no longer needed in the primed view and the patient is no longer needed in the tracking list.

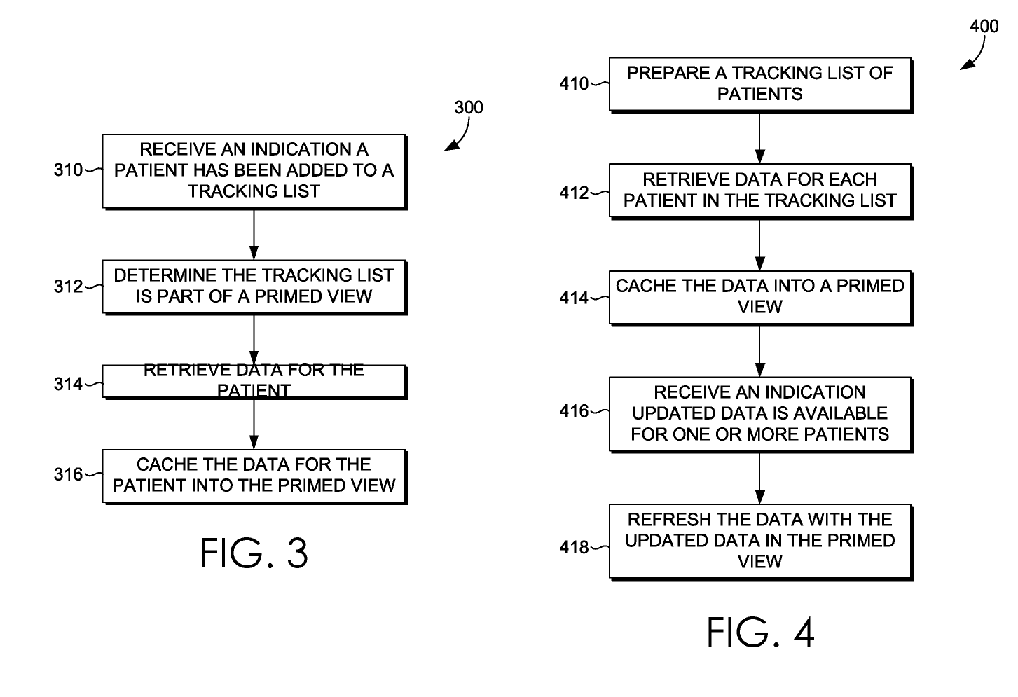

With reference to FIG. 3, an exemplary flow diagram representative of a method for populating a custom data mart, in accordance with an embodiment of the present invention is shown and referenced generally by numeral 300. Method 300 may be implemented using the above-described exemplary computing system environment (FIG.1). Initially, as shown at step 310, an indication a patient has been added to a tracking list is received. In one embodiment, a schedule of appointments. The schedule of appointments may be for a particular hour, day, week, and the like. Patients are added to the tracking list based on the schedule of appointments. This allows the tracking list to be created automatically (e.g., from the schedule) rather than requiring the tracking list to be created manually (e.g., by a clinician).

The tracking list is determined, at step 310, to be part of a primed view. The primed view comprises a particular format or data. In one embodiment, a selection of data to include in the primed view is received. The selection of data may include defined rows and columns based on a condition associated with the patients included in the tracking list. The selection of data may include defined rows and columns based on a role associated with a clinician. The selection of data may include defined rows and columns based on a unit associated with a healthcare facility. This allows the primed view to be tailored appropriately for the clinician that will view the data.

Data for the patient is retrieved at step 314. The data may be limited in time so that only the most recent data is retrieved. The data may also be limited in scope to conform to the format that comprises the primed view. In other words, a query is not executed to retrieve all data for the patient. Rather, the query is limited to retrieve only what is necessary for the clinician for the current encounter with the patient.

The data for the patient is cached, at step 316, into the primed view. In one embodiment, the data for the patient is cached into the primed view before the patient is admitted. In one embodiment, the data for the patient is cached into the primed view before the patient arrives at the healthcare facility. In one embodiment, the data for the patient is cached into the primed view when the patient checks in to the healthcare facility. This allows the data in the primed view to be available to the clinician as the clinician attends to, treats, or interacts with the patient.

In one embodiment, an indication a new order or result is available for at least one patient in the tracking list is received. The order or result may be entered by the clinician viewing the primed view or by another clinician that has recently had an encounter with the patient. The indication alerts the clinician that the primed view needs to be refreshed. In one embodiment, the updated data is retrieved for the at least one patient. In one embodiment, the updated data is cached into the primed view. This allows the clinician to view the primed view with the updated data included. In one embodiment, the primed view is updated automatically when the updated data is received. In one embodiment, the primed view is updated manually by the clinician such as upon the clinician being alerted that a new order or result is available, allowing the clinician to manually select for the updated data to be retrieved and cached into the primed view.

In one embodiment, an indication the patient has been discharged is received. In one embodiment, an indication the appointment is complete for the patient is received. The data for the patient may be removed from the primed view and the patient may be removed from the tracking list. In one embodiment, the data for the patient may be removed automatically from the primed view when the indication is received. Similarly, the patient may be removed from the tracking list when the indication is received. In another embodiment, the data for the patient may not be removed until an indication is received from the clinician that indicates the data is no longer needed in the primed view. Similarly, the patient may be removed from the tracking list when an indication is received from the clinician that indicates the patient is no longer needed in the tracking list (i.e., the appointment is complete or the patient has been discharged and the clinician has completed charting for the patient).

With reference to FIG. 4, an exemplary flow diagram representative of a method for denormalizing healthcare data, in accordance with an embodiment of the present invention is shown and referenced generally by numeral 400. Method 400 may be implemented using the above-described exemplary computing system environment (FIG. 1). Initially, as shown at step 410, a tracking list of patients is prepared. The tracking list is based on a schedule of appointments.

Data is retrieved for each patient in the tracking list at step 412. The data is limited in time and selected based on a condition associated with the patients, a role associated with a clinician, and/or a unit associated with a healthcare facility. Retrieving data that is limited in time allows the clinician to view the most recent data (e.g., orders and/or results) without needing to scroll through or review data from every encounter for each patient. Selecting the data based on a condition allows only the most relevant data to be retrieved. For example, a clinician may be treating patients that have a particular condition. Only certain data for this condition may actually be relevant to the clinician. Similarly, certain data may only be relevant to a clinician with a particular role or to a particular unit of the healthcare facility. Rather than retrieving all available data, only data that is relevant to the treatment of the patient for the current encounter is retrieved.

At step 414, the data is cached into a primed view. The primed view is available to the clinician without the clinician requesting the data. In other words, the data may be automatically retrieved based on the tracking list (e.g., daily schedule of appointments, weekly schedule of appointments, etc.). This allows the most recent and relevant data to be available for each patient on the tracking list without the clinician needing to request any information.

An indication is received, at step 416, that updated data is available for one or more patients. For example, data may have been updated that is not yet available in the primed view. An order may have been placed by the clinician or another clinician. Similarly, results may be available that were not available when the data was initially cached in the primed view. The indication may alert the clinician that more recent data is available. At step 418, the data is refreshed with the updated data in the primed view. In one embodiment, the data may be refreshed automatically, such as after a particular time has elapsed after the indication is received or in real-time when the data is available.

In one embodiment, an indication is received that the appointment is over for a patient. The data may be removed for the patient from the primed view. In one embodiment, the data is automatically removed when the patient checks out from the appointment or is discharged from the facility. In one embodiment, the data is removed when the clinician manually removes the data. In one embodiment, the patient is removed from the tracking list. In one embodiment, the patient is automatically removed from the tracking list when the patient checks out from the appointment or is discharged from the facility. In one embodiment, the patient is manually removed from the tracking list by the clinician. In one embodiment, removing the patient from the tracking list removes the data for the patient from the primed view.

As can be understood, the present invention provides systems, methods, and user interfaces for selective denormalization of healthcare data. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. Computer storage media having computer-executable instructions embodied thereon, that when executed, perform a method of facilitating selective denormalization of healthcare data, the method comprising:
receiving an indication a patient has been added to a tracking list;
determining the tracking list is associated with a primed view;
retrieving data for the patient; and
caching the data for the patient into the primed view before a clinician requests the data.

2. The media of claim 1, further comprising receiving a schedule of appointments.

3. The media of claim 2, further comprising adding the patient to the tracking list based on the schedule of appointments.

4. The media of claim 3, wherein the data for the patient is cached into the primed view before the patient is admitted.

5. The media of claim 1, further comprising receiving an indication a new order or result is available for at least one patient in the tracking list.

6. The media of claim 5, further comprising receiving updated data for the at least one patient.

7. The media of claim 6, further comprising caching the updated data into the primed view.

8. The media of claim 1, further comprising receiving an indication the patient has been discharged.

9. The media of claim 8, further comprising removing the data for the patient from the primed view.

10. The media of claim 9, further comprising removing the patient from the tracking list.

11. The media of claim 10, further comprising retrieving a selection of data to include in the primed view.

12. The media of claim 11, wherein the selection of data is based on a condition associated with the patient.

13. The media of claim 11, wherein the selection of data is based on a role associated with a clinician.

14. The media of claim 11, wherein the selection of data is based on a unit associated with a healthcare facility.

15. Computer storage media having computer-executable instructions embodied thereon, that when executed, perform a method of facilitating selective denormalization of healthcare data, the method comprising:
preparing a tracking list of patients based on a schedule of appointments;
retrieving data for each patient in the tracking list, the data limited in time and selected based on a condition associated with the patients, a role associated with a clinician, a configurable definition, and/or a unit associated with a healthcare facility;
caching the data into a primed view, the primed view available to the clinician without the clinician requesting the data;
receiving an indication updated data is available for one or more patients; and
refreshing the data with the updated data in the primed view.

16. The media of claim 15, further comprising receiving an indication the appointment is over for a patient.

17. The media of claim 16, further comprising removing the data for the patient from the primed view.

18. The media of claim 17, further comprising removing the patient from the tracking list.

19. A computer system for facilitating the selective denormalization of healthcare data, the computer system comprising one or more processors coupled to a computer hardware storage medium, the computer hardware storage medium having stored thereon a plurality of computer software components executable by the one or more processors, the computer software components comprising:
a tracking component that receives an indication a patient has been added to a tracking list;
a retrieval component that retrieves data for each patient in the tracking list, the data limited in time and selected based on a condition associated with the patients, a role associated with a clinician, a configurable definition, and/or a unit associated with a healthcare facility;
a cache component that caches the data into a primed view, the primed view provided before a user initiates a query; and
a refresh component that retrieves updated data and refreshes the data with the updated data in the primed view.

20. The system of claim 19, further comprising:
a discharge component that indicates an appointment has ended for the patient or the patient has been discharged;
a removal component that removes the data for the patient from the primed view and removes the patient from the tracking list.
